(19) United States
(12) Patent Application Publication
(10) Pub. No.: US 2006/0125313 A1
(43) Pub. Date: Jun. 15, 2006

(54) Method and device for stabilizing a semi-trailer

(75) Inventors: Harald Gunne, Stuttgart (DE); Frank-Werner Mohn, Weil Im Schoenbuch (DE); John Michael Williams, Detroit, MI (US)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/535,735

(22) PCT Filed: Nov. 20, 2003
(86) PCT No.: PCT/EP03/12987

§ 371 Date: Dec. 21, 2005

(30) Foreign Application Priority Data
Nov. 22, 2002 (DE) 102 54 810.2

(51) Int. Cl. B60T 13/00

(52) U.S. Cl. 303/7

(57) ABSTRACT

In a method and apparatus for stabilizing a vehicle combination (composed of a towing vehicle with front and rear wheels and a trailer or semi-trailer at least one dynamic movement input variable is determined and evaluated. If a rolling movement of the vehicle combination is detected at least braking interventions for stabilizing the dynamic movement state of the vehicle combination are brought about for the towing vehicle. According to the invention, a yaw moment which counteracts the rolling movement of the vehicle combination is produced solely by means of braking interventions which are brought about for the front wheels of the towing vehicle.

### BACKGROUND AND SUMMARY OF THE INVENTION

This application claims the priority of German patent application 102 54 810.2, filed Nov. 22, 2002 (PCT International Application No. PCT/EP2003/012987, filed Nov. 20, 2003, the disclosure of which is expressly incorporated by reference herein.

The invention relates to a method and a device for stabilizing a vehicle combination.

Vehicle combinations (a trailer and a towing vehicle) tend to carry out rolling movements as the speed increases. For the sake of simplicity, the term “rolling movement” will be used below to designate the unstable state of a vehicle combination which can be eliminated using the method or apparatus according to the invention. This is not, however, intended to constitute a restriction, and the terms oscillating movement or rolling movement can also be used to designate this state.

More specifically, if a vehicle combination experiences a rolling movement, the trailer oscillates about its vertical axis and also excites oscillations in the towing vehicle via the trailer hitch. If the speed of the vehicle is below what is referred to as a critical speed, the oscillations are damped. If the speed of the vehicle is equal to the critical speed, the oscillations are undamped. If the speed of the vehicle is above the critical speed, the excited oscillations no longer decay automatically, but reinforce one another. The vehicle combination is subject to greater and greater rocking in its transverse movement which may lead, under certain circumstances, to an accident.

The rolling movement may be excited, for example, by steering interventions by the driver which are unsuitable for a specific driving situation, as a result of traveling over a bump or as a result of the effect of side wind influences.

The magnitude of the critical speed depends, inter alia, on geometry data such as wheelbase and tow bar length, on the mass and the yaw inertia moment of the towing vehicle and of the trailer, and on the oblique running rigidities of the tires and/or axles. The critical speed varies typically in the region from 70 to 130 kilometers per hour in vehicle combinations in the passenger car field. The frequency of the rolling movement is approximately 0.5 to 2 Hz.

If a rolling movement occurs, an essentially periodic transverse movement occurs at the towing vehicle which is towing the trailer. Such transverse movement may be expressed, for example, in the transverse acceleration or the yaw angle rate of the towing vehicle. As a result, during a rolling movement, an essentially periodic signal of the transverse acceleration or of the yaw rate occurs. This is not a strictly periodic oscillation phenomenon, since the vehicle combination does not constitute an ideal oscillating system. Instead, temporal fluctuations in the period length of the oscillating movement of the trailer can occur. These are expressed, for example, in a repeating or essentially periodic signal which is produced by a transverse acceleration sensor. That is, this signal has a period length which changes within small limits, and which is however ideally to be considered as constant over time. The same also applies to the signal of a yaw rate sensor.

Correspondingly, a yaw moment which is to be impressed and with which the yaw moment which originates from the rolling movement is to be compensated is also not strictly periodical. The period length in the yaw moment to be impressed is also changed in accordance with the fluctuations in the period of the rolling movement or oscillating movement of the vehicle combination.

A large number of differing methods and devices for stabilizing vehicle combinations are known from the prior art. For example, the publication “Aktive Gespannstabilisierung beim BMW X5 [Active vehicle combination stabilization on the BMW X5]” which appeared on pages 330 to 339 in the Automobiltechnischen Zeitschift (ATZ) [Automobile Periodical] 104, 2002, Issue 4 describes a device for stabilizing vehicle combinations with which oscillations which occur independently of the properties of the particular vehicle combination and the traveling speed are detected, and when certain limiting values are exceeded the vehicle combination can be returned to the safe traveling state again by active braking of the towing vehicle. The detection of the oscillation is based essentially on an analysis of the measured yaw rate. The yaw rate is filtered with a bandpass filter which is dimensioned to the frequency band 0.5 Hz and 1.0 Hz, and the amplitude of the filtered signal is determined.

By reference to this yaw amplitude it is decided whether a braking intervention is necessary to stabilize the vehicle combination. In addition to the instantaneous value of the yaw amplitude, the behavior of the yaw amplitude over time is also evaluated. If an unstable state of the vehicle combination is detected, the towing vehicle is braked symmetrically at all four wheels by actively building up pressure until the oscillating movement has sufficiently decayed.

For this purpose, a constant value for the setpoint deceleration is predefined, said value being set by a deceleration controller. At the same time the drive torque is limited to zero. In addition to the symmetrical braking intervention, the wheel-specific braking interventions which originate from a yaw rate controller can also be carried out during an oscillating movement and then superimposed on the symmetrical braking intervention.

German patent document DE 195 36 620 A1 describes a method for improving the transverse stability of a vehicle combination. According to this method, vehicle-decelerating measures are taken if the amplitude of a dynamic transverse vehicle variable, for example the transverse acceleration or the yaw angle rate, oscillates within a predefined frequency band and at the same time exceeds a limiting value. The vehicle-decelerating measures are interventions for reducing the angle of aperture of the throttle valve in order to reduce the drive torque and/or interventions for feeding brake pressure to the front wheels and the rear wheels of the towing vehicle.

German patent document DE 100 31 266 A1 describes a method and apparatus for detecting an oscillating movement of a vehicle. The vehicle is equipped with means for influencing the torque which is output by the engine, and with brakes which are assigned to the wheels of the vehicle. When an oscillating movement is detected, the means for influencing the torque which is output by the engine and the brakes are actuated (both to the same extent) in order to reduce the speed of the vehicle. Alternatively there is provision, when an oscillating movement of the vehicle is detected, to actuate the wheel brakes individually in such a way that a yaw moment which acts on the vehicle and which counteracts the oscillating movement is produced.

German patent document DE 100 34 222 A1 describes a method and a device for stabilizing a vehicle combination. If a rolling movement is detected, stabilizing interventions are carried out. In a first procedure, correctly phased braking interventions are carried out at the brakes of the towing vehicle. At the same time the brakes of the trailer are braked uniformly. As an alternative to the correctly phased braking interventions at the towing vehicle it is possible to perform corresponding steering interventions. In a second procedure only the trailer is braked selectively.

German patent document DE 199 64 048 A1 describes a method and apparatus for stabilizing a vehicle combination. If a rolling movement is detected for the vehicle combination, an essentially periodic yaw moment which is essentially antiphase to the rolling movement is impressed by automatically braking the road vehicle with different braking forces on the two sides of the road vehicle, such that the vehicle is automatically braked on one side.

After and/or in addition to the impressing of the essentially periodic yaw moment the road vehicle is automatically briefly braked in such a way that the overrun brake of the trailer is triggered. This brief braking can be carried out by intervening in the wheel brakes of the towing vehicle or by reducing the drive torque. Depending on the level of equipment of the vehicle different braking interventions are carried out. If the vehicle is equipped with a yaw rate controller (ESP, FDR), all the wheels of the towing vehicle can be braked individually in order to impress the essentially periodic yaw moment. Furthermore, all the wheels can also be braked simultaneously or the engine power can be reduced by corresponding engine interventions so that the overrun brake of the trailer is activated. If the vehicle has rear wheel drive or all wheel drive and is equipped with a traction controller system (TCS), the essentially periodic yaw moment can be impressed by braking interventions at the rear axle. If, in contrast, the vehicle has front wheel drive and is equipped with a traction controller system (TCS), the stabilizing possibility described above is not available. In this case, all that is possible is to brake all the wheels of the towing vehicle. Even in the case of a vehicle which is equipped only with an anti-lock brake system (ABS), all the wheels of the towing vehicle are braked in order to stabilize the vehicle combination, which leads at the same time to activation of the overrun brake of the trailer.

German patent document DE 100 07 526 A1 describes a method and apparatus for stabilizing the dynamic movement state of vehicle combinations. If an unstable dynamic state is detected, the longitudinal speed of the towing vehicle is reduced by intervening in the engine and/or in the brakes of the towing vehicle. As an alternative to the interventions by which the longitudinal speed of the towing vehicle is reduced, it is possible to carry out a one-sided braking intervention at the towing vehicle, which brings about a reduction in the bending angle.

A disadvantage of the methods or devices for stabilizing a vehicle combination which are known from the prior art is that braking interventions are either carried out mainly or exclusively at the rear wheels or else the front wheels, and the rear wheels are always braked together (i.e., simultaneously), specifically either uniformly or individually. This type of braking intervention causes longitudinal forces, (i.e., circumferential forces), to be produced at the rear wheels, which at the same time brings about a reduction in lateral guiding forces that would be required to stabilize a rolling vehicle combination. In other words, these braking interventions at the rear wheels reduce the lateral guiding force potential at said wheels. If the underlying surface conditions correspond (for example when there is a low coefficient of friction of the underlying surface due to water or snow-covered or icy underlying surface), this can lead to an increase or amplification of the unstable behavior of the vehicle combination (i.e., the rolling movement of the vehicle combination), even though the braking interventions performed for stabilization purposes are actually intended to eliminate the unstable behavior of the vehicle combination.

One object of the invention, therefore, is to provide an improved method for stabilizing vehicle combinations.

Another object of the invention is to provide a method in which, during the period of time in which the interventions for stabilizing the vehicle combination are carried out, a lateral guiding force potential which is sufficient to stabilize the vehicle combination is present or ensured predominantely at the rear wheels of the towing vehicle.

These and other objects and advantages are achieved by the method according to the invention, in which at least one dynamic movement input variable is determined and evaluated. If a rolling movement of the vehicle combination is detected by means of the evaluation, at least braking interventions for stabilizing the dynamic movement state of the vehicle combination are brought about for the towing vehicle. According to the invention, a yaw moment which counteracts the rolling movement of the vehicle combination is produced solely by means of braking interventions which are brought about for the front wheels of the towing vehicle, independently of the driver.

The fact that the yaw moment which counteracts the rolling movement of the vehicle combination is produced solely by means of the braking interventions for the front wheels ensures that a lateral guiding force potential which is sufficient to stabilize the vehicle combination is available, in particular at the rear wheels.

So that this lateral guiding force potential which is so significant is not reduced, according to the principle employed, the execution of braking interventions at the rear wheels of the towing vehicle is dispensed with, or largely dispensed with. Braking interventions for the rear wheels of the towing vehicle are permitted or brought about in addition to the braking interventions mentioned above for the front wheels only when a predefined operating state of the vehicle combination is present. This ensures that in specific situations in which the braking effect which is brought about at the front wheels is not sufficient to stabilize or decelerate the vehicle combination in an enduring fashion, it is possible to increase the total braking effect acting on the vehicle combination, and thus to bring about deceleration, which in turn leads to a situation in which the vehicle combination can be stabilized better.

According to the present invention, braking interventions which give rise to braking forces that are composed of a basic force and a dynamic force component are advantageously brought about for the front wheels. In comparison with braking interventions which produce only a uniform (i.e., constant) braking force, such braking interventions (which can be referred to as “oscillating”) have the advantage that they make it is possible to generate a counter-yaw moment which counteracts the rolling movement of the vehicle combination. This counter-yaw moment is essentially in antiphase to the rolling movement of the vehicle combination. A counter-yaw moment cannot be built up using braking interventions with which a uniform or constant braking effect is produced. If, for example, all the wheels of the vehicle are braked simultaneously in such a way that a uniform or constant braking effect is produced at the wheels, the moments which are produced by these braking interventions and which act on the vehicle cancel one another out; a counter-yaw moment cannot be built up with this type of braking intervention.

Since the aim is to use the permitted additional braking interventions for the rear wheels to increase the deceleration acting on the vehicle combination, these braking interventions are carried out at the rear wheels in such a way that they bring about an essentially constant braking effect. Modulation of the braking interventions for the rear wheels which is also performed would lead to a modulating reduction in the lateral guiding force potential at the rear wheels, and is therefore not carried out.

The build up of the additional braking effect at the rear axle is advantageously carried out in such a way that the value of the vehicle deceleration which has occurred due to the braking process which is initiated or carried out by the driver is maintained. The driver thus continues to be provided with the deceleration which he can sense. There are no distractions as a result of a possibly changing deceleration during the stabilizing interventions which are carried out independently of the driver.

The braking process which is initiated or carried out by the driver is what is referred to as a driver-dependent braking operation which is based on activation of the brake pedal by the driver. Such a braking operation can be sensed by the initial pressure set by the driver or by a signal which is output by a brake light switch or by a signal which represents the deflection of the brake pedal.

A predefined operating state of the vehicle combination, in which braking interventions for the rear wheels are permitted, is present, for example, if a rolling movement of the vehicle combination is detected, while at the same time there is no braking by the driver and the vehicle combination is located on an underlying surface with a low coefficient of friction. That is, under these circumstances, braking interventions for the rear wheels are also permitted. In this configuration, stabilizing interventions which are independent of the driver are not necessarily performed. Instead, precautions are taken to ensure that such interventions can be made if there is a need for them. As a result, where necessary, quick stabilization of the vehicle combination is possible.

A predefined operating state of the vehicle combination, in which braking interventions is applied to the rear wheels, is present, for example, if a rolling movement of the vehicle combination is detected at a time when there is no braking by the driver and the braking interventions applied to the front wheels lead to a risk of the front wheels locking. In this situation, in addition to the instability caused by the rolling movement of the vehicle combination, further instability occurs, specifically that which is caused by possibly locking front wheels.

This further instability is eliminated automatically by an anti-lock brake system (ABS) with which the vehicle combination is equipped. For this purpose, the anti-lock brake system actuates the brake actuators assigned to the front wheels, in such a way that the braking force which is exerted at the front wheels is reduced, or is applied to such an extent that locking of the front wheels is avoided. Since the braking force which is necessary at the front wheels in order to stabilize the vehicle combination cannot be built up alone in the present operating state of the vehicle combination (that is, a significant deceleration of the vehicle cannot be brought about by the braking interventions at the front wheels), corresponding braking interventions are brought about at the rear wheels of the towing vehicle. With this configuration it is better to brake all the wheels simultaneously in order to implement a deceleration of the vehicle combination, and thus a reduction in kinetic energy.

Whether there is a risk of the front wheels locking can be determined, for example, by evaluating the slip at the front wheels, or else by evaluating an ABS flag which indicates, in the present operating state, that braking interventions are performed at least for a front wheel by an anti-lock brake system, in order to avoid locking of this wheel. That is to say it is appropriate to check whether one of the front wheels is subjected to wheel slip control by the anti-lock brake system.

A further predefined operating state of the vehicle combination, in which braking interventions are applied to the rear wheels is, for example, if a rolling movement is detected during a braking process which is initiated or carried out by the driver and the vehicle deceleration occurring as a result of that braking process fulfills a predefined comparative criterion. In this situation, additional braking interventions for the rear wheels are brought about.

If the vehicle deceleration is below a predefined threshold value, the rear wheel braking effect which results from a driver initiated braking process is thus at least partially reduced by the braking interventions for the rear wheels. This measure is taken therefore in order to ensure that a lateral guiding force potential at the rear wheels of the towing vehicle is sufficient to stabilize the vehicle combination. This loss of braking effect which occurs at the rear wheels is compensated by the braking effect which occurs at the front wheels as a result of the basic force. At the same time it is ensured that the driver does not experience any perceptible change in the deceleration set by him due to the stabilizing interventions carried out independently of the driver.

The braking effect which occurs at the rear wheels as a result of the driver initiated braking process is preferably reduced to such an extent that the vehicle deceleration which has resulted from such braking process is at least maintained. However, the intention is to make it possible for a safety system which is contained in the towing vehicle (for example an ESP system) to be able to request a higher braking effect (and thus a greater vehicle deceleration), thus also being able to set such an effect and such deceleration.

On the other hand, if the vehicle deceleration is above a predefined threshold value, the braking effect which occurs at the rear wheels as a result of the driver initiated braking process is thus at least maintained by the braking interventions which are brought about for the rear wheels. This measure is intended to ensure that strong driver braking which may be necessary due to a particular traffic situation is maintained. An example of this is strong braking of the vehicle combination which is desired by the driver and which is intended to reduce the kinetic energy of the vehicle combination to a minimum in the event of an unavoidable rear-end collision.

If an intervention of an anti-lock brake system (ABS) is made simultaneously at one or both front wheels when there is vehicle deceleration above the predefined threshold value, an additional braking effect is increased at the rear axle by rear wheel braking interventions. The reduction in deceleration which originates from the interventions of the anti-lock brake system due to the reduction in the basic force at the front wheels is thus compensated.

For rear wheel braking interventions, the following procedure is also possible in the case under consideration: At first in accordance with the invention, a reduction in the braking effect is first permitted at the rear wheels by means of corresponding braking interventions. However, if an intervention of an anti-lock brake system is detected for at least one of the front wheels and at the same time it is ascertained that the present vehicle deceleration does not correspond to that desired by the driver, the braking effect at the rear wheels is increased again by corresponding braking interventions.

If at least the towing vehicle is equipped with a hydraulic or electrohydraulic or pneumatic or electropneumatic brake system, the front wheel braking interventions lead to a situation in which a brake pressure composed of a basic pressure and dynamic pressure peaks is fed into the wheel brake cylinders assigned to the front wheels. This division corresponds to the division represented above into a basic force and dynamic force component. In this context the yaw moment which counteracts the rolling movement of the vehicle combination is produced by the dynamic force component or the dynamic pressure peaks. Although the basic pressure which is fed in at the two front wheels creates a moment which acts on the vehicle with respect to the individual front wheel, since the basic pressure is fed in symmetrically at both front wheels, these two moments do not give rise to any yaw moment when superimposed on one another. The basic pressure which is fed in at the front wheels thus does not bring about any rotation of the vehicle about its vertical axis.

The value of the basic force or pressure is advantageously determined as a function of a deviation in the yaw angle rate. This deviation advantageously results from the difference between the actual value for the yaw angle rate (which is determined using a yaw angle rate sensor) and a setpoint value for the yaw angle rate (which is determined using a mathematical model). Determining the value of the basic force or the basic pressure as a function of the deviation of the yaw angle rate has the following advantage: if, for example, the setpoint value is subtracted from the actual value, the setpoint value can then be represented as a zero line with respect to the excitation energy, while the actual value represents the excitation energy of the rolling vehicle combination. Consequently the deviation represents a measure of the excitation energy which is to be reduced by stabilizing braking interventions. Since rolling movements of the vehicle combination increase at speeds above the critical speed, and stabilizing braking interventions are therefore necessary for compensation, the deviation is also a measure of the kinetic energy to be reduced. The value of the deviation thus permits the intensity of the braking interventions to be carried out to be defined.

The value for the dynamic force component or for the dynamic pressure peaks is advantageously determined as a function of a variable which describes the change over time of a deviation in the yaw angle rate. Various procedures are possible for determining this variable. For example, it can be determined as a derivative over time in the control error which is present for the yaw angle rate (i.e., the deviation in the actual value of the yaw angle rate from the associated setpoint value). This variable consequently corresponds, as it were, to a deviation between an actual and a setpoint value for the yaw angle acceleration. This variable can also be determined directly as a deviation of the yaw angle acceleration from an associated setpoint value in a particular driving situation. The reason why the value is determined for the dynamic force component or dynamic pressure peaks as a function of this variable is as follows: the yaw moment which originates from the rolling movement of the vehicle combination is proportional to the yaw acceleration. Thus, the most effective compensation of the rolling movement can be achieved by making the pressure peaks, which are intended to implement the compensation, proportional to the yaw acceleration. If the setpoint value of the yaw angle rate is zero, the deviation for the yaw angle rate corresponds to its actual value. At the same time, the variable which describes the change over time in the deviation for the yaw angle rate corresponds to the actual value of the yaw angle rate.

It is has proven advantageous that both the basic pressure and the dynamic pressure peaks decrease as the rolling movement decreases. The stabilizing interventions which are carried out independently of the driver are thus adapted to the degree of instability.

Advantageously, engine interventions are also carried out in addition to the braking interventions, thereby enhancing the deceleration effect for the vehicle combination. The torque which is output by the engine is advantageously set by these engine interventions in such a way that no (or nearly zero) circumferential forces occur at the driven wheels of the towing vehicle. In other words, the frictional losses which occur in the drive train are compensated and the driven wheels are given a neutral setting as far as the circumferential force is concerned. (That is, they are essentially given a setting which is free of circumferential force). The last-mentioned measure ensures that a high degree of lateral guidance potential force is available. The suitable drive torque which is applied to the driven wheels via the drive train improves the compensation of the rolling movement of the vehicle combination. Depending on the design of the vehicle engine, the engine interventions influence, for example, the position of the throttle valve or the ignition angle or the injection quantity.

After the stabilizing braking interventions have been initiated, it is advantageously checked whether the instability of the vehicle combination decreases. If it is detected in the process that the vehicle combination has reached a stable state again, no further stabilizing braking interventions are produced. At the same time, the drive torque is set in accordance with the value which is predefined by the driver, derived from the activation of the accelerator pedal. This measures ensures there is a transition, with accent on comfort, from the travel situation which was present before the stabilizing interventions which were independent of the driver were carried out, and the travel situation which is present after the aforesaid interventions have been carried out. Disruptive, possibly sudden, changes in the longitudinal dynamics are avoided.

At least the yaw angle rate of the towing vehicle is advantageously determined and evaluated as a dynamic movement input variable. The vehicle speed, the yaw angle rate and the steering angle are advantageously evaluated in order to determine whether a rolling movement is occurring. In this context, a rolling movement is occurring if the yaw angle rate exhibits an oscillating behavior when the vehicle speed is higher than an associated threshold value and the driver is not making any steering interventions. The threshold value which is given above for the vehicle speed is advantageously lower than the critical speed. It lies, for example, in a range above 55 kilometers per hour, preferably between 55 and 60 kilometers per hour.

Advantageously, the presence of a rolling movement of the vehicle combination is detected as a function of a deviation variable which represents the deviation between the actual value of the yaw angle rate and an associated setpoint value. If this deviation reaches or exceeds a predefined threshold value, this is an indication that a rolling movement of the vehicle combination is occurring. By taking into account or evaluating the control error it is possible, for example, to detect a slalom movement which is desired by the driver (and during which the vehicle combination is not unstable, and there is thus also no need for stabilizing interventions).

The method and apparatus according to the invention also make it possible for an average driver to cope with an unstable vehicle combination (i.e., a vehicle combination which has a rolling movement), and permit rapid attenuation of a yaw reaction. A further advantage is that, because of the vehicle dynamic systems which are already in series production today (for example, a yaw rate controller known as ECP, which is found on vehicles of the applicant) there is no need for any additional actuation or sensor systems. Moreover, no changes to the trailer are necessary. (That is, there is no need to mount an actuator or sensor system on the trailer, so that trailers which are already in operation do not need to be retrofitted.)

If it is detected that there is a rolling movement for the vehicle combination or if the vehicle detects the inclination or tendency to execute a rolling movement, stabilizing interventions are performed. These are in the first instance braking interventions which are carried out independently of the driver and in the second instance engine interventions.

The braking interventions are intended to reduce the yaw moments which originate from the rolling movement and act on the vehicle. They are therefore performed in such a way that as to produce a counter-yaw moment which acts on the vehicle. For this purpose, braking intervention are first carried out on the front wheels of the vehicle as a function of the value of the sensed yaw moment acting on the vehicle and/or of the value of the sensed yaw acceleration in such a way that they counteract the yaw moment originating from the rolling movement. As a result, the energy of the rolling movement (i.e., the oscillation energy) is reduced, and the vehicle combination stabilizes and travels in a stable way again.

Other objects, advantages and novel features of the present invention will become apparent from the following detailed description of the invention when considered in conjunction with the accompanying drawings.

### BRIEF DESCRIPTION OF THE DRAWINGS

FIG. 1 shows two situations of an unstable vehicle combination, for explaining the basic procedure of the method according to the invention;

FIG. 2 is a diagram which shows signal profiles of different variables which are significant in conjunction with the method according to the invention;

FIG. 3 is a functional block diagram that shows the method of operation on which the method according to the invention is based;

FIG. 4 shows the detection logic which is used in the method according to the invention, in the form of a functional block illustration;

FIGS. 5a, 5b, 5c and 5d illustrate the determination of different variables in the detection logic in the form of functional block illustrations;

FIG. 6 is a functional block diagram that shows the structure of intervention logic which is used in the method according to the invention;

FIGS. 7a and 7b are functional block illustrations that show the components of the intervention logic for determining actuation signals for carrying out braking interventions and engine interventions;

FIGS. 8a, 8b and 8c show the procedure for determining the actuation signals for carrying out the braking interventions, in the form of functional block illustrations;

FIG. 9 shows, on the one hand, a schematic illustration of the device according to the invention and, on the other hand, the essential steps of the method according to the invention which runs in the device according to the invention, in the form of a block circuit diagram.

### DETAILED DESCRIPTION OF THE DRAWINGS

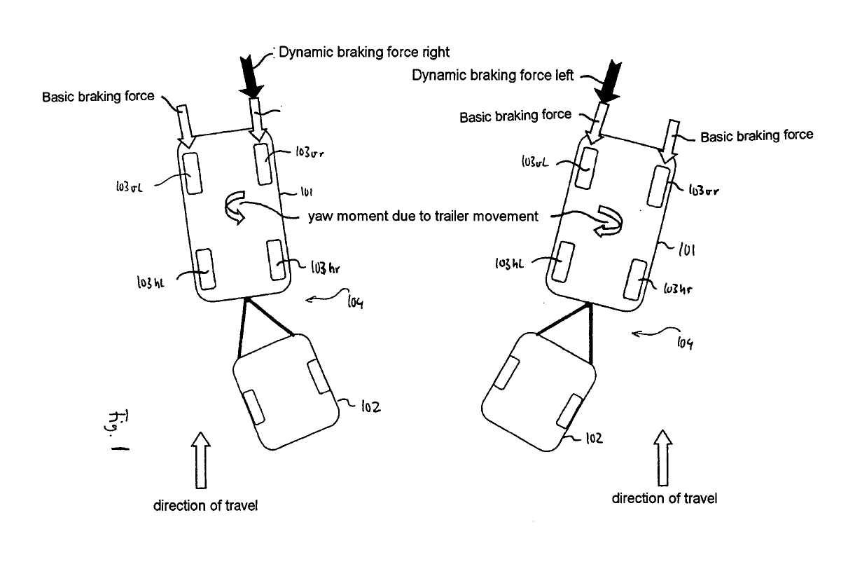

FIG. 1 illustrates the basic procedure for the braking interventions which are carried out at the front wheels according to the inventive method. In the left-hand representation, the trailer 102 oscillates to the right, which causes the towing vehicle 101 to execute a left-handed rotation about its vertical axis, as indicated by the arrow. Due to the detected rolling movement of the vehicle combination 104, a basic braking force is fed in at both front wheels 103vl, 103vr of the towing vehicle. In addition, a dynamic braking force which leads to a yaw moment which is directed to the right and acts on the towing vehicle 101 is fed in at the right-hand front wheel 103vr. This yaw moment which is brought about by the dynamic braking force counteracts the yaw moment which is brought about by the rolling movement, and thus stabilizes the vehicle combination 104.

In the right-hand illustration, the trailer 102 oscillates to the left, which causes the towing vehicle 101 to execute a right-handed rotation about its vertical axis, as indicated by the arrow. Due to the detected rolling movement of the vehicle combination 104, a basic braking force is fed in at both front wheels 103vl, 103vr of the towing vehicle. In addition, a dynamic braking force which leads to a yaw moment which is directed to the left and acts on the towing vehicle 101 is fed in at the left-hand front wheel 103vl. This yaw moment which is brought about by the dynamic braking force counteracts the yaw moment which is brought about by the rolling movement, and thus stabilizes the vehicle combination 104.

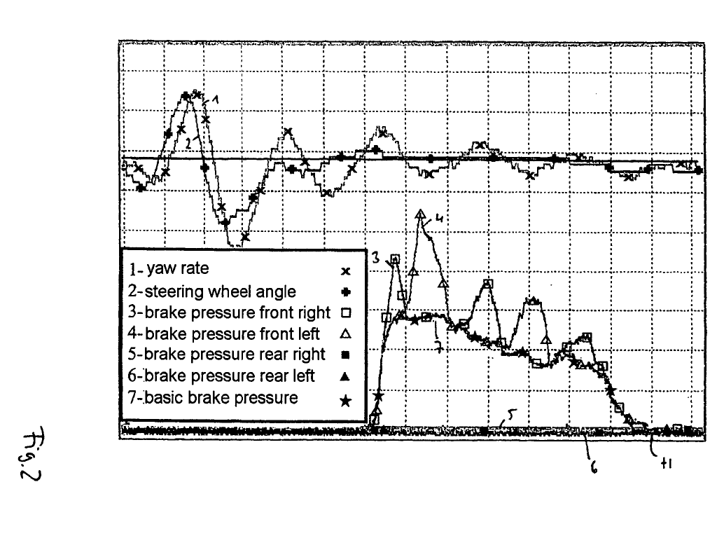

This procedure is also illustrated in the diagram in FIG. 2, which shows, at the upper part of the diagram, the signal profiles for the yaw rate and the steering angle. The lower part of this diagram shows the signal profiles for the brake pressures which are set at the individual wheels 103vl, 103vr, 103hl, 103hr of the towing vehicle and the signal profile of the basic brake pressure, which are fed in together at the front wheels 103vl, 103vr. As is apparent from the signal profiles, the brake pressures supplied to the two front wheels 103vl, 103vr is composed of a basic brake pressure and of dynamic pressure peaks.

The upper part of the diagram illustrates the following travel situation: the driver produces a rolling movement of the vehicle combination 104 by corresponding steering wheel (and thus steering) movements 2 (in this instance a double steering jump). The rolling movement of the vehicle combination 104 is thus due to the steering movements initiated by the driver. The rolling movement of the vehicle combination 104 is shown in an oscillating behavior of the signal profile of the yaw angle rates which is sensed using a yaw angle rate sensor. The following convention applies here: a positive value of the yaw angle rate indicates a deflection of the trailer 102 to the right and thus at the same time a deflection of the towing vehicle 101 to the left, while a negative value of the yaw angle rate signifies a deflection of the trailer 102 to the left and thus at the same time a deflection of the towing vehicle 101 to the right.

The method of excitation of a rolling movement which is described above is not intended to have a restrictive effect on the method according to the invention. Of course, and this was the actual motivation for implementing the method according to the invention: to make it possible to eliminate rolling movements of a vehicle combination 104 which are excited from the outside (i.e., independently of the driver).

The lower part of the diagram shows the braking interventions which are carried out using the method according to the invention, based on the detected rolling movement of the vehicle combination 104. At first it is apparent that a certain period of time passes between the occurrence of the oscillating yaw angle rate and the application of pressure. This is due to the fact that at first the rolling movement has to be detected using a corresponding evaluation on which further details will be given below. In addition, by reference to the profiles 5 and 6 it is apparent that no brake pressure is being fed in at the two rear wheels 103hl, 103hr. As already stated above, on the one hand a basic pressure is applied which leads to the basic braking force mentioned above and, on the other hand, wheel-specific pressure peaks are applied, which lead to the dynamic braking forces mentioned above are supplied to the two front wheels 103vl, 103vr.

The basic pressure is illustrated by the profile 7, and the pressure peaks are shown in profiles 3 and 4. As is apparent from the diagram illustrated in FIG. 2, when the trailer 102 is deflected to the right and there is thus a deflection of the towing vehicle 101 to the left, a pressure peak is fed in at the right-hand front wheel 103vr. Correspondingly, when the trailer 102 is deflected to the left and there is thus a deflection of the towing vehicle 101 to the right a pressure peak is fed in at the left-hand front wheel 103vl.

The value of the basic pressure to be supplied is determined as a function of a deviation in the yaw angle rate. This deviation results from the difference between the actual value for the yaw angle rate (which is determined using a yaw angle rate sensor) and a setpoint value for the yaw angle rate (determined using a mathematical model, in the present case a vehicle model).

The values for the pressure peaks which are to be applied are determined as a function of a value or a variable which describes the change over time of the deviation in the yaw angle rate. This variable can be determined, for example, as a time derivative in the control error which is present for the yaw angle rate (i.e., the deviation in the actual value of the yaw angle rate from the associated setpoint value). This variable can also be determined directly as a deviation of the yaw angle acceleration which is present in the respective travel situation from an associated setpoint value, with the actual value being subtracted from the setpoint value. Due to its lower complexity, the first alternative is to be preferred.

The basic braking force due to the basic brake pressure which is applied at the front wheels 103vl, 103vr causes braking of the vehicle combination 104. As a result, the speed of the vehicle combination 104 is reduced to a value which is lower than the critical speed mentioned at the beginning.

The braking forces which are generated by the pressure peaks at the front wheels 103vl, 103vr lead, on the one hand, to braking of the vehicle combination 104. On the other hand, the oscillating feeding of the pressure peaks causes what is referred to as a counter-yaw moment to be impressed. Such counter-yaw moment is in antiphase (or opposed) to the yaw moment originating from the rolling movement. This counter-yaw moment reduces the rolling movement of the vehicle combination 104 extremely quickly. The vehicle combination 104 is stabilized.

After the stabilizing braking interventions have been initiated, it is checked whether the instability of the vehicle combination 104 (i.e., the rolling movement of the vehicle combination 104) decreases. If it is detected that a stable state of the vehicle combination 104 has been reached again, no further braking interventions are produced in order to produce the basic brake pressure and the pressure peaks. At the same time, the drive torque is set again in accordance with a value predefined by the driver, which can be derived from the activation of the accelerator pedal by the driver.

The procedure which is described above for the braking interventions is also shown in the diagram in FIG. 2. Starting from the time t1, the signal profile of the yaw angle rate has only a very small amplitude, so that no further braking interventions are performed at this time. As can also be inferred from this diagram, both the basic brake pressure and the pressure peaks decrease generally as the rolling movement decreases. The speed of the vehicle combination is below the critical speed.

In the procedure illustrated in the diagram in FIG. 2 and in the underlying travel situation, braking interventions are carried out only at the front wheels 103vl, 103vr. That is, a yaw moment which counteracts the rolling movement of the vehicle combination 104 is produced solely by means of the braking interventions which are brought about for the front wheels 103vl, 103vr of the towing vehicle 101, and the vehicle combination 104 is thus stabilized. The travel situation under consideration is thus not intended to correspond to an operating state of the vehicle combination 104 in which additional braking interventions for the rear wheels 103hl, 103hr are permitted or brought about. More details relating to braking interventions at the rear wheels 103hl, 103hr and on the corresponding operating states of the vehicle combination 104 are given below.

As already mentioned, engine interventions can also be carried out in addition to the braking interventions. For this purpose, for example, in the case of a spark ignition engine, the throttle valve is set in such a way that a zero torque is produced at the driven wheels. If the towing vehicle is a vehicle with rear wheel drive, the two rear wheels 103hl, 103hr are the driven wheels. The throttle valve angle which is set in this context is between 6° and 10°. In other words: as a result of the engine interventions the throttle valve is set in such a way that little or no circumferential forces occur at the driven wheels. That is, the throttle valve is set in such a way that the friction losses which occur in the drive train are compensated and the driven wheels are given a neutral setting as far as the circumferential force is concerned.

With respect to FIG. 2 it is to be noted that a yaw moment which counteracts the rolling movement of the vehicle combination 104 is produced solely by means of the braking interventions for the front wheels 103vl, 103vr of the towing vehicle 101, as a result of which the vehicle combination 104 is stabilized. In addition, braking interventions can also be permitted or brought about at the rear wheels 103hl, 103hr. Details are given below on the patterns according to which the stabilizing braking interventions are carried out, independently of the driver, both for the front wheels 103vl, 103vr and for the rear wheels 103hl, 103hr.

If there is no braking by the driver, the front wheels 103vl, 103vr are braked. For this purpose, the basic pressure whose value is determined as a function of the deviation of the actual value of the yaw angle rate from the setpoint value of the yaw angle rate is fed in for both front wheels 103vl, 103vr. In addition, the pressure peaks whose values are each determined as a function of the deviation of the yaw acceleration are each applied to the front wheels 103vl, 103vr. In such an operating state (there is no braking by the driver), attempts are made to stabilize the vehicle combination 104 by means of braking interventions which are carried out exclusively at the front wheels 103vl, 103vr. However, if there is such a low coefficient of friction of the underlying surface (for example, due to snow or the like) that braking force necessary to stabilize the vehicle combination 104 cannot be built up at the front wheels 103vl, 103vr alone, then the rear wheels 103hl, 103hr are also braked. In such a context brake pressure can be redistributed away from the front wheels 103vl, 103vr to the rearwheels 103hl, 103hr. The fact that braking is occurring on an underlying surface with a low coefficient of friction can be detected, for example, by evaluating the ABS flag. With the ABS flag an anti-lock brake system indicates that braking interventions are performed at least for one vehicle wheel in order to prevent this wheel from locking. In principle, in order to detect whether the vehicle is located on an underlying surface with a low coefficient of friction it is also possible to evaluate a variable which describes the coefficient of friction. Such a variable is present, for example, in a dynamic movement system where the yaw rate of a vehicle is controlled.

If a rolling movement of the vehicle combination 104 occurs during a braking process which is initiated by the driver, the vehicle combination 104 is stabilized by means of braking interventions as follows: at first the vehicle deceleration which results from the braking process initiated by the driver is determined. If this vehicle deceleration is below a predefined threshold value (which means that a braking process with a low deceleration has been initiated by the driver), the brake pressure set at the rear wheels 103hl, 103hr as a result of the braking process which is occurring is at least partially reduced. At the same time, brake pressure is built up at the front wheels 103vl, 103vr in such a way that, on the one hand, the basic pressure is fed into both front wheels 103vl, 103vr and a pressure peak is specifically fed into the respective front wheel. In this case it is also possible, if braking is being carried out on an underlying surface with a low coefficient of friction, to implement a redistribution of brake pressure away from the front wheels 103vl, 103vr to the rear wheels 103hl, 103hr.

If, on the other hand, the vehicle deceleration is above the predefined threshold value (which means that a braking process with a high deceleration has been initiated by the driver), the brake pressure set at the rear wheels 103hl, 103hr is left. At the front wheels 103vl, 103vr the brake pressure is modulated in order to produce a dynamic yaw moment which is in antiphase to the yaw moment due to the rolling movement of the vehicle combination 104. If an intervention of an anti-lock brake system (ABS controller) is made at one front wheel or both front wheels 103vl, 103vr during such a braking operation, brake pressure is additionally applied to the rear axle. As a result, it is possible for the anti-lock brake system to reduce the brake pressure at the front wheels 103vl, 103vr in a modulating fashion to such an extent that locking of one or both front wheels 103vl, 103vr is avoided, without reducing the deceleration which acts on the vehicle combination 104. Pressure can even be applied to the rear axle to such an extent that the rear wheels 103hl, 103hr are brought to their locking limit.

As an alternative to evaluating the vehicle deceleration it is also possible to detect whether a braking process is occurring with a high or low deceleration, by evaluating the state of the front wheels 103vl 103vr. For this purpose it is possible, for example, to evaluate the value of the brake pressure which is supplied to the respective wheel brake cylinders of the front wheels 103vl, 103vr, or to evaluate the actuation of the inlet and outlet valves of the front wheels 103vl, 103vr. Alternatively, it is also possible to evaluate the brake slip occurring at the front wheels 103vl, 103vr.

To summarize, it is to be noted with respect to the braking interventions that, in the first instance stabilizing braking interventions are carried out at the front wheels 103vl, 103vr. By evaluating a predefined criterion or when predefined operating states of the vehicle combination 104 are present it is possible that, in addition to the braking interventions carried out for the front wheels 103vl, 103vr, braking interventions are also carried out at the rear wheels 103hl, 103hr in order to produce a braking force.

A rolling movement of the vehicle combination 104 is sensed by the sensor system which is provided in the towing vehicle 101 in connection with the dynamic movement system with which the towing vehicle 101 is equipped (commonly referred to as a yaw rate controller, ESP). Consequently, at least vehicle speed, yaw angle rate and the steering angle are evaluated in order to determine whether a rolling movement is occurring.

The method according to the invention is composed of two main parts, as illustrated in FIG. 3: first, a detection logic component 301 which detects a rolling movement of the vehicle combination 104, and second, an intervention logic component 302 which carries out stabilizing braking interventions, engine interventions, and/or steering interventions if a rolling movement of the vehicle combination 104 is occurring. The variables which are required in the detection logic component 301 for processing are made available to it via a CAN bus which is provided in the towing vehicle 101, while the variables required in the intervention logic component 302 are provided both on the basis of the detection logic component 301 and also likewise via the CAN bus. Both the variables produced by the detection logic component 301 and those produced by the intervention logic component 302 are output onto the CAN bus, in each case via a suitable interface which is contained in the respective logic component.

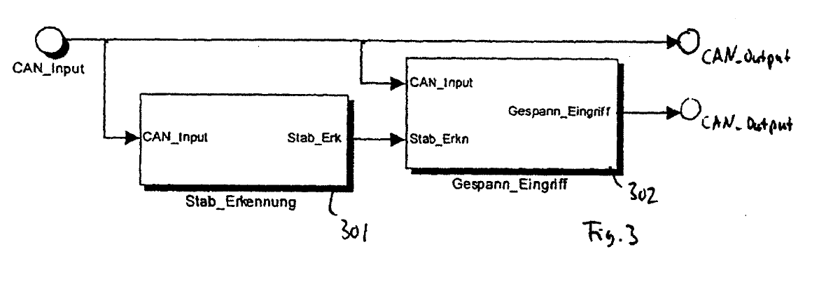

The method of functioning of the detection logic component 301 will be described below with reference to FIG. 4. The detection logic component 301 detects whether a rolling movement of the vehicle combination 104 (i.e., a rolling movement of the trailer 102) is occurring. Different vehicle variables are evaluated for this purpose. In particular, the yaw angle rate, the steering angle and the vehicle are evaluated.

The criterion for detecting the occurrence of a rolling movement of the vehicle combination 104 (and thus, a rolling movement of the trailer 102) can be generally formulated as follows: an operating state of the vehicle combination 104 in which the vehicle speed is higher than or equal to an associated threshold value is considered. The threshold value is lower here than the critical speed. If the yaw angle rate exhibits an oscillating behavior in this operating state even though the driver does not activate the steering wheel and thus does not carry out any steering interventions, this is an indication that a rolling movement of the vehicle combination 104 (and thus, the trailer 102) and an unstable state of the vehicle combination 104 are occurring. This means that in order to detect whether a rolling movement of a vehicle combination 104 is occurring, it is appropriate to evaluate the vehicle speed, the yaw angle rate and the steering angle.

Since rolling movements can occur in a vehicle combination 104 whose speed is below the critical speed but such movements are dissipated again automatically, it can be assumed from the outset that in an operating state in which the vehicle does not reach the critical speed, stabilizing interventions, such as are carried out according to the inventive method, are unnecessary. If, on the other hand, the speed of the vehicle combination is above the critical speed, the rolling movements of the vehicle combination increase, so that appropriate stabilizing interventions are carried out.

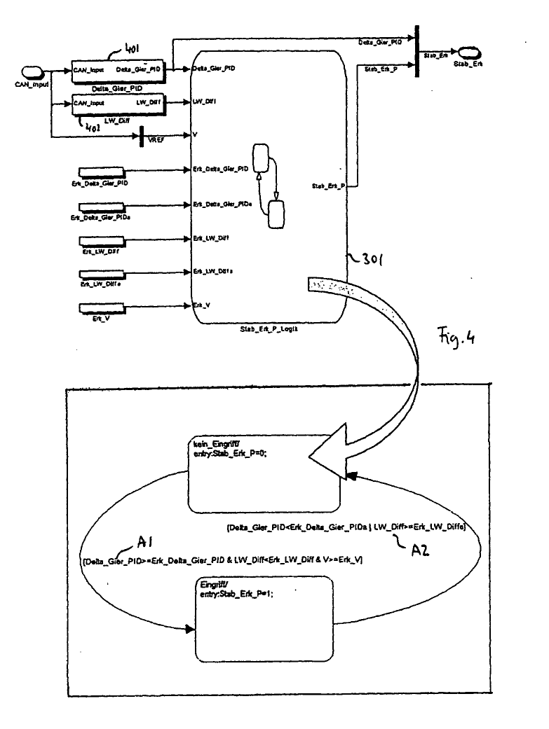

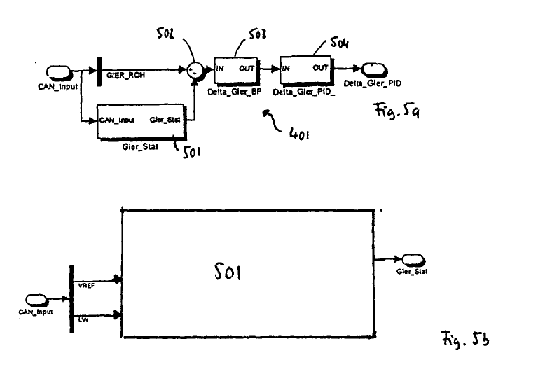

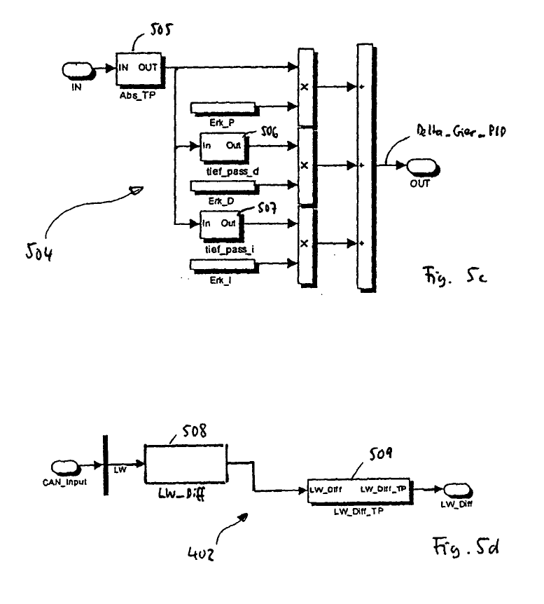

As is apparent from FIG. 4, different variables are fed to the detection logic component 301. In the first instance these are the variables which are to be evaluated, comprising a variable Delta_Gier_PID, a variable LW_Diff and a variable v. The variable Delta_Gier_PID is determined as a function of the yaw angle rate, in a block 401 which is described in conjunction with FIG. 5a. The variable LW_Diff is determined as a function of the steering angle, in a block 402 which is described in conjunction with FIG. 5d. The variable v is the speed of the vehicle combination 104 which is also referred to as the reference speed. In the second instance these variables are Erk_Delta_Gier_PID, Erk_Delta_Gier_PIDa, Erk_LW_Diff, Erk_LW_Diffa and Erk_V. These variables represent parameters which can be set, which have the function of threshold values and with which the abovementioned variables Delta_Gier_PID, LW_Diff and v are compared.

As is apparent from the two-part illustration in FIG. 4, two interrogations are made in the detection logic component 301. A first interrogation A1 detects whether a rolling movement of the vehicle combination 104 is occurring. According to this first interrogation a rolling movement of the vehicle combination 104 is occurring if i) the variable Delta_Gier_PID is greater than or equal to the threshold value Erk_Delta_Gier_PID; ii) at the same time the variable LW_Diff is lower than the threshold value Erk_LW_Diff; and iii) at the same time the vehicle speed V is higher than or equal to the threshold value Erk_V. If it is detected that a rolling movement is occurring, stabilizing interventions are necessary, so that the flag Stab_Erk_P is set, i.e. this flag is assigned the value 1.

In addition, a second interrogation by A2 detects whether the rolling movement has decayed again. According to this second interrogation a rolling movement of the vehicle combination 104 is no longer occurring if the variable Delta_Gier_PID is lower than the threshold value Erk_Delta_Gier_PIDa, or if the variable LW_Diff is higher than or equal to the threshold value Erk_LW_Diffa. If it is detected that a rolling movement is no longer occurring, stabilizing interventions are no longer necessary, and the flag Stab_Erk_P is therefore deleted (assigned the value 0).

As is apparent from the two interrogations A1 and A2, different threshold values are used for the two variables Delta_Gier_PID and LW_Diff, so that a hysteresis function results.

The flag Stab_Erk_P is output by the detection logic component 301 and is thus available to the components in which this flag is further processed. In particular it is available to the intervention logic component 302.

The method of determining different variables which are required in the detection logic component 301 will be described using FIGS. 5a, 5b, 5c and 5d. FIGS. 5a, 5b and 5c illustrate how the variable Delta_Gier_PID is determined.

According to FIG. 5a, in the first instance the actual value GIER_ROH of the yaw angle rate, which is measured using a yaw angle rate sensor, and in the second instance a setpoint value Gier_Stat of the yaw angle rate, which is determined from predefined driver values, are input into the means for determining the variable Delta_Gier_PID. The actual value GIER_ROH is made available via the CAN bus and the setpoint value Gier_Stat is determined in a block 501. The difference Delta_Gier which is fed to a downstream bandpass filter 503 is formed from these two variables by a difference former 502.

As is apparent from the illustration in the block 501 in FIG. 5b, the setpoint value Gier_Stat is determined using a mathematical model as a function of the steering angle LW and the vehicle speed VREF, which are set by the driver. For example the Ackermann relationship, which is known from the literature, can be used as a mathematical model.

As is apparent from FIG. 5a, the difference Delta_Gier is fed to a bandpass filter 503 which transmits only signals which lie in a frequency range from 0.5 to 2 Hz. This frequency range corresponds to the frequency range which is typical of the rolling movement of a vehicle combination 104; it is also referred to as the natural frequency range of the vehicle combination 104. The difference Delta_Gier, which in terms of its significance is the control error of the dynamic movement system which is arranged in the towing vehicle 101 and has the purpose of controlling the yaw rate (ESP), is thus filtered, using a bandpass filter, for the subsequent detection of a possible rolling movement of the vehicle combination 104. If the vehicle combination 104 rolls, a signal which changes over time and is in the form of an oscillation is thus present after the bandpass filtering, said signal generally being a pure sinusoidal or cosinusoidal oscillation. The signal Delta_Gier_BP which is determined using the bandpass filter 503 is fed to a downstream block 504 whose function will be described using FIG. 5c.

The variable Delta_Gier_BP, (i.e., the filtered control error) which is prepared by the bandpass filter 503 is further processed, using the unit illustrated in FIG. 5c, to form a variable Delta_Gier_PID which is used to detect a rolling movement of the vehicle combination 104. At the same time, this variable is used to determine the basic pressure to be fed into the front wheels. Evaluating the control error, i.e., the deviation of the actual value of the yaw angle rate from the associated setpoint value, has the following advantage over simply evaluating the signal determined using the yaw rate sensor, i.e. the actual value of the yaw rate: by evaluating the control error it is possible, for example, to detect a slalom movement which is desired by the driver and during which there is no instability of the vehicle combination, and there is thus also no need for stabilizing interventions.

At first, the absolute value of the signal Delta_Gier_BP is determined using a lowpass filter 505. By multiplying by a factor Erk_P a proportional component is obtained, which can be used to check how strong the rolling movement is. The proportional component indicates if an oscillation of significant size occurs after a disruption has acted on the vehicle combination. In addition, the absolute value signal which is produced using the lowpass filter 505 is fed to a block 506 which forms the time derivative of the absolute value signal. The signal which is produced with the block 506 is multiplied by a factor Erk_D, as a result of which a differential component is obtained with which it is possible to check whether the rolling movement is decreasing or increasing. The differential component also indicates instabilities which are due to short-term disruption, for example, gusts of wind, which act on the vehicle combination. Alternatively it is also possible to feed the absolute value signal from the lowpass filter 505 to a block 507 where it is integrated. By multiplying the signal determined in the block 507 by a factor Erk_I an integral component is obtained which has the following significance: for example when the vehicle combination is traveling at a speed which is near to the critical speed it is possible for continuous, slight rolling of the vehicle combination to occur. Such a rolling behavior is sensed using the integral component. If the integral component exceeds a predefined value, this is an indication that this slight rolling process has already been occurring for a relatively long time, for which reason stabilizing interventions in order to eliminate it are necessary, and are carried out. Taking into account the integral component is optional and is not necessarily provided with the method according to the invention.

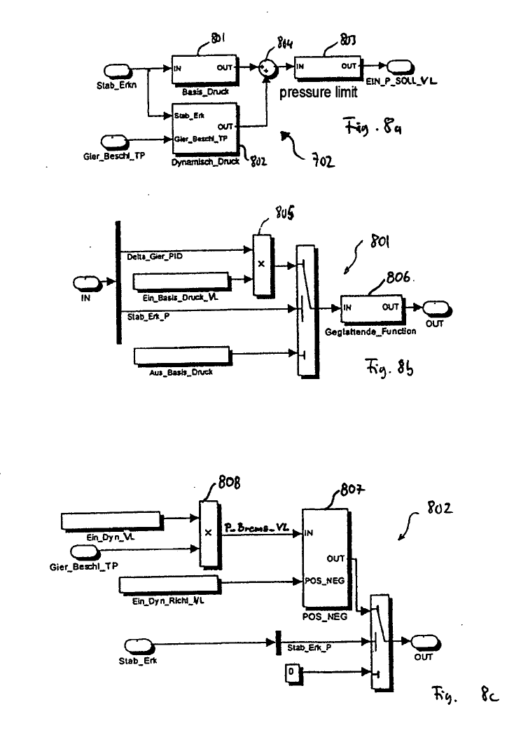

The proportional component, the differential component, and, if one is present, also the integral component, are subsequently combined to form the signal Delta_Gier_PID, which is output from block 504, is fed for further processing to the detection logic component 301, and to a component 805 which is shown in FIG. 8b.

FIG. 5d illustrates the method of determining the variable LW_Diff.

In determining whether a rolling movement of the vehicle combination 104 is occurring, the variable LW_Diff is also evaluated in the detection logic component 301, because an evaluation of the yaw angle rate alone or of a variable which is determined as a function of the yaw angle rate is too imprecise. If the steering angle were not also evaluated, it would not be possible to differentiate between an instability which is due to a rolling movement of the vehicle combination 104 and a slalom movement which is initiated intentionally by the driver by means of steering interventions. According to the illustration in FIG. 5d, the steering angle is evaluated in such a way (and thus the variable LW_Diff is determined in such a way), that at first the derivative of the steering angle over time is formed in a block 508 and said derivative is subsequently lowpass filtered in a block 509. These measures filter out small steering movements of the driver which are insignificant.

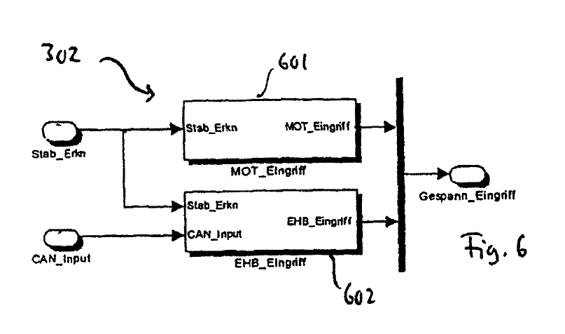

The illustration in FIG. 6 shows the structure of the intervention logic component 302. As is apparent, two types of intervention are carried out in order to stabilize the vehicle combination 104. On the one hand and in the first instance, braking interventions which are brought about using a block 602, and on the other hand and in a supporting fashion, if necessary, engine interventions are brought about using a block 601.

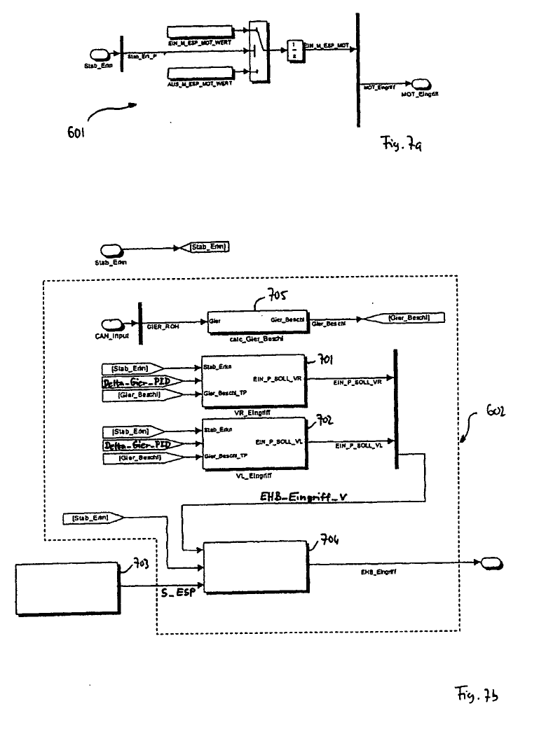

FIG. 7a shows the implementation of the block 601 and thus the procedure when the actuation signals for carrying out the engine intervention are determined. The illustrated circuit has the following function: if the flag Stab_Erk_P assumes the value 1 (meaning that a rolling movement of the vehicle combination 104 is occurring), the signal EIN_M_ESP_MOT whose value corresponds up to this point to the engine torque predefined by the driver assumes the value EIN_M_ESP_MOT_WERT. As a result the engine torque is reduced in such a way that no circumferential forces, or circumferential forces which are near to zero, occur at the driven wheels of the towing vehicle 101. The value EIN_M_ESP_MOT_WERT is determined, for example, as a function of the degree of efficiency of the drive train and/or of the selected gearspeed and/or of the drag torque of the towing vehicle. If the flag Stab_Erk_P assumes the value 0 (there is no longer any rolling movement in the case under consideration), the signal EIN_M_ESP_MOT assumes the value AUS_M_ESP_MOT_WERT. As a result, the drive torque is set again in accordance with the value predefined by the driver. In this context the transition is carried out using a suitably selected transition function so that the transition does not cause the driver to be adversely affected.

FIG. 7b illustrates the implementation of the block 602, and thus the procedure for determining the actuation signals for carrying out the braking interventions. Two blocks 701 and 702 determine the actuation signals for stabilizing braking interventions at the front wheels 103vl, 103vr, the actuation signals for the right-hand front wheel 103vr being determined in block 701, and the actuation signals for the left-hand front wheel 103vl being determined in block 702. The actuation signals for carrying out braking interventions at the rear wheels 103hl, 103hr are determined in blocks 703 and 704.

The blocks 701, 702, 703 and 704 in FIG. 7b can be used to supply brake pressure to the wheels of the vehicle on a wheel-specific basis. The basic pressure or the basic force and the pressure peaks or the dynamic forces can thus be set at the front wheels 103vl, 103vr. In addition, the brake pressures can be distributed between the front wheels and the rear wheels, as is necessary in certain predefined operating states of the vehicle combination.

The yaw acceleration Gier_Beschl is determined in block 705. For this purpose, the signal GIER_ROH which is fed to this block is firstly lowpass filtered. The derivative of the lowpass filtered signal over time is then formed and is itself lowpass filtered. The signal Gier_Beschl which is produced in the process is then output by the block 705 and fed, for example, to the blocks 701 and 702. In addition, the flag Stab_Erk_P which is contained in the signal grouping Stab_Erkn, and the variable Delta_Gier_PID are also fed to the two blocks 701 and 702.

The structure of the two blocks 701 and 702 is explained below using FIGS. 8a, 8b and 8c, and details on these will be given first below. Details on the implementation of the two blocks 703 and 704 will then be given.

FIG. 8a illustrates the structure of the block 702 with which the actuation signals EIN_P_SOLL_VL are determined for carrying out the braking interventions for the left-hand front wheel 103vl. The structure of the block 701 which is assigned to the right-hand front wheel 103vr is identical. The same applies to the illustrations in FIGS. 8b and 8c.

The illustration in FIG. 8a shows that the actuation signals are composed of two components—a first component for setting the basic pressure or the basic force which is determined in a block 801, and a second component for setting the pressure peaks or the dynamic forces, which is determined in a block 802. These two components are added in a summing element 804. A block 803 is used to limit this summing signal. This measure ensures that the brake pressure which is to be set at the front wheels 103vl, 103vr does not exceed a value which is predefined for the respective brake system. The limited summing signal is output as an actuation signal EIN_P_SOLL_VL.

FIG. 8b illustrates the structure of the block 801 and thus the procedure for determining the component of the actuation signal with which the basic pressure is set. As is apparent from the illustration in FIG. 8b, this component is proportional to the variable Delta_Gier_PID. That is, this component is determined as a function of a deviation which is present for the yaw angle rate. The proportionality to the variable Delta_Gier_PID causes the basic force to increase in the case of relatively severe oscillation, in this case the P component is larger. The same also applies to undamped oscillation.

If the flag Stab_Erk_P has the value 1 (a rolling movement of the vehicle combination 104 is occurring), the signal produced in the multiplier 805 as a product of the variables Delta_Gier_PID and Ein_Basis_Druck_VL is output. The variable Ein_Basis_Druck_VL is an applied gain factor which is dependent on the configuration of the brake system and preferably has a constant value within the range from 70 to 140 bar. If, on the other hand, the flag Stab_Erk_P has the value 0, the signal Aus_Basis_Druck, which has a predefined small value, is output, causing brake pressure to be fed in. This is intended to ensure that no inadvertent feeding in of brake pressure occurs if there is no rolling movement. The signal which is to be output is smoothed using a block 806.

FIG. 8c illustrates the structure of the block 802 and thus the procedure for determining the component of the actuation signal with which the pressure peaks are set. As shown in FIG. 8c, this component is proportional to the variable Gier_Beschl_TP and thus to the yaw acceleration. That is, the component of the actuation signal for producing the pressure peaks is determined as a function of the yaw acceleration. Since the yaw moment which originates from the rolling movement is proportional to the yaw acceleration, information is thus available as to which front wheel is to be braked in order to be able to produce an anti-phase yaw moment for the rolling movement. The variable Gier_Beschl_TP is acquired in the block 702 by lowpass filtering from the signal Gier_Beschl which is fed to said block.

If the flag Stab_Erk_P has the value 1 (a rolling movement of the vehicle combination 104 is occurring), the component of the actuation signal which is made available by a block 807 and which brings about the pressure peaks is output. Otherwise the value 0 is output.

The product of the two variables Gier_Beschl_TP and Ein_Dyn_VL is determined using a multiplier 808, thereby converting the variable Gier_Beschl_TP (which corresponds physically to a yaw acceleration) into a variable P_Brems_VL which corresponds physically to a pressure. The variable P_Brems_VL is fed to the block 807.

In block 807, a signal is determined on the basis of the signal P_Brems_VL, and is output. This signal is used to carry out, at the left-hand front wheel, such braking interventions which produce, of course, in conjunction with corresponding braking interventions carried out at the right-hand front wheel, a yaw moment which counteracts the rolling movement.

As already explained, the signal Gier_Beschl_TP corresponds to the yaw acceleration. In the mathematical sense, this signal constitutes the time derivative of the profile 1 of the yaw angle rate which is illustrated in FIG. 2. (For the sake of clarity the signal profile of the yaw acceleration has not been illustrated in FIG. 2; however, it is essentially a signal which is offset by 90° and is an advance of the signal of the yaw angle rate.) Both the signal Gier_Beschl_TP and the signal P_Brems_VL exhibit an oscillating behavior.

In order to be able to generate on the basis of the oscillating signal P_Brems_VL a signal which can be used to carry out correctly phased braking interventions at the left-hand front wheel, the block 807 is embodied as a comparator which operates as follows:

Within the scope of the present exemplary embodiment the block 807 is intended only to output the positive signal components of the signal P_Brems_VL. For this purpose, the signal P_Brems_VL is compared with a comparative variable Eim_Dyn_Richt_VL in the block 8/7. If the signal P_Brems_VL equals or exceeds the value of the comparative variable Ein_Dyn_Richt_VL, the amount of the excess of the signal P_Brems_VL is output by the block 807. The components of the signal P_Brems_VL which undershoot the value of the comparative variable Ein_Dyn_Richt_VL are not output; instead the block 807 outputs the signal 0.

The comparative variable Ein_Dyn_Richt_VL preferably has the value 0. Due to the definition of this value, the positive halfwaves of the signal P_Brems_VL are output by block 807 and the negative halfwaves are suppressed. The method of functioning of the block 807 can also be described in such a way that it outputs the maximum value of the two variables P_Brems_VL and Ein_Dyn_Richt_VL.

The block 802 which is used for the right-hand front wheel 103vr in the block 701 corresponds in terms of structure to that which is illustrated in FIG. 8c, but with the difference that the factor Ein_Dyn_VR which is used for the right-hand front wheel 103vr is negative. As a result, the negative halfwaves which are contained in the signal Gier_Beschl_TP, for determining the actuation signal with which the pressure peaks are produced at the right-hand front wheel 103vr, are taken into account for the right-hand front wheel 103vr, and the positive half waves are filtered out.

To summarize it is to be noted that: the positive halfwaves of the signal Gier_Beschl_TP are taken into account for the left-hand front wheel 103vl, and the negative halfwaves of said signal are taken into account for the right-hand front wheel 103vr.

After the method of operation of the two blocks 701 and 702 has been described, the two blocks 703 and 704 which are illustrated in FIG. 7b will then be described.

Block 703 constitutes an ESP system which is arranged in the towing vehicle and with which the yaw angle rate of the towing vehicle is controlled. This ESP system has sensors for sensing the wheel speeds of the individual wheels of the towing vehicle, the steering angle, the lateral acceleration and the yaw angle rate. Using a vehicle speed which is determined as a function of the wheel speeds, and the steering angle, a setpoint value for the yaw angle rate is determined by means of a mathematical model. The setpoint value is compared with the actual value which is determined for the yaw angle rate, and when a deviation is present, stabilizing wheel-specific braking interventions and engine interventions are carried out. The braking interventions are used to produce yaw moments which act on the towing vehicle and have the purpose of compensating an oversteering or understeering travel behavior of the towing vehicle. The engine torque which is output by the engine is reduced using the engine interventions, which ultimately leads to a reduction in the vehicle speed.

Signals S_ESP coming from the ESP system 703 are fed to the block 704. The signals S_ESP contain, inter alia, the actuation signals which are determined by the ESP system and have the purpose of carrying out the stabilizing braking interventions, and further signals which are required in the block 704, inter alia for determining the operating states of the vehicle combination. In this particular case these are the following signals: i) a variable which describes the longitudinal acceleration of the vehicle combination; ii) a variable which describes the coefficient of friction of the underlying surface on which the vehicle combination is moving (estimated, for example, on the basis of a variable which describes the lateral acceleration and a variable which describes the longitudinal acceleration); and iii) a variable which represents the braking requirement of the driver, and which represents the activation of the brake pedal and/or the initial pressure set by the driver. In addition, the flag Stab_Erk_P and the actuation signals EHB_Eingriff_V which are produced using the two blocks 701 and 702 are fed to the block 704.

As long as the flag Stab_Erk_P has the value 0, (no rolling movement is occurring for the vehicle combination), the actuation signals which are produced by the ESP system 703 are output as signals EHB_Eingriff. As soon as the flag Stab_Erk_P has the value 1 (a rolling movement is occurring for the vehicle combination), the signals EHB_Eingriff_V which are produced in the blocks 701 and 702 for the front wheels and the actuation signals for the rear wheels are output as signals EHB_Eingriff, said actuation signals carrying out the braking interventions at the rear wheels which correspond to the respective operating state. The actuation signals for the rear wheels are produced or modified in the block 704.

At this point it is to be noted that the function of the subordinate anti-lock brake system which is contained in the ESP system runs along permanently in the background. As soon as the tendency to lock is detected for a wheel, appropriate braking interventions are performed in order to reduce the brake pressure.

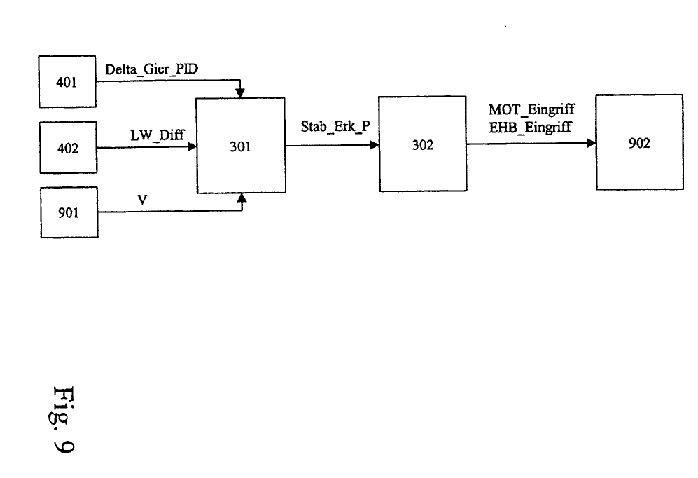

FIG. 9 is a block circuit diagram which shows both a schematic illustration of the device according to the invention and the essential steps of the method according to the invention which runs in the device according to the invention. At this point, no more details will be given on the function or the structure of the blocks 301, 302, 401 and 402, as the latter have already been described in detail above.

The following variables are fed to the detection logic component 301: i) the variable Delta_Gier_PID coming from the block 401; and ii) the variable LW_Diff coming from the block 402. In addition, the variable V (vehicle speed) is fed to the detection logic component 301 coming from a block 901. The block 901 comprises wheel speed sensors which are assigned to the individual wheels of the towing vehicle 101 as well as suitable means with which the signals which are made available by the wheel speed sensors are converted into the variable V. As a function of these variables, the detection logic component 301 detects whether or not a rolling movement is occurring for the vehicle combination 104. If so, the detection logic component 301 outputs the value 1 for the flag Stab_Erk_P. When the value 1 is present for the flag Stab_Erk_P the variables MOT_Eingriff and EHB_Eingriff are determined in the intervention logic component 302, and fed to a block 902. Stabilizing braking interventions are carried out using the individual actuation signals which are combined to form the variable EHB-Eingriff. For this purpose, either brake actuators which are assigned directly to the individual wheels of the towing vehicle 101 can be actuated by these actuation signals or else these actuation signals are fed to a control device which is assigned to the brake system of the towing vehicle 101. In addition, engine interventions are preformed using the variable Mot_Engriff. The block 902 comprises the brake actuators and/or the control device which is assigned to the brake system of the towing vehicle and/or actuators for carrying out the engine interventions.

The vehicle can be equipped with a hydraulic, electrohydraulic, pneumatic, or electropneumatic, or electromechanical brake system. The important factor is that the brake system can be used to carry out wheel-specific braking interventions which are independent of the driver, specifically in such a way that a braking force can be built up, maintained or reduced at the individual wheels. This condition is fulfilled, for example, by brake systems such as are used nowadays in vehicles that are equipped with a dynamic movement system (ESP). Such a dynamic movement system is used to stabilize the vehicle about its vertical axis by controlling the yaw angle rate.

In addition to, or instead of, the stabilizing braking interventions it is also possible, if the vehicle has a corresponding actuation system, to carry out stabilizing steering interventions. These steering interventions must also be carried out in a correctly phased way in accordance with the stabilizing braking interventions so that the steering interventions produce a yaw moment which counteracts the rolling movement of the vehicle combination.

The vehicle combinations which are considered in conjunction with the method and apparatus according to the invention are intended to be, for example, combinations from the passenger car field which are composed of a towing vehicle and a trailer, for example a motor home trailer, a car transportation trailer or a boat trailer. However, it is also conceivable to use the method according to the invention and the device according to the invention in vehicle combination from the field of utility vehicles, which are composed of a towing vehicle and a semitrailer or pole trailer.

Although the method according to the invention and the device according to the invention have been described above exclusively in conjunction with vehicle combinations, since the problem of rolling occurs to a greater degree with vehicle combinations and is far more dangerous with such combinations than in individual vehicles, it is to be noted at this point that the use of the device according to the invention and the method according to the invention is also conceivable for individual vehicles.

To conclude, the idea on which the method according to the invention and the device according to the invention are based will be summarized once more without taking into account the already existing prior art: The method according to the invention relates to a method for stabilizing a vehicle combination which is composed of a towing vehicle and a trailer, wherein at least one dynamic movement input variable is determined and evaluated, and wherein a braking intervention and/or engine intervention for stabilizing the dynamic movement state of the vehicle combination for is brought about for the towing vehicle if an unstable dynamic movement state is detected by means of the evaluation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-29. (canceled)

30. A method for stabilizing a vehicle combination of a trailer or semi-trailer and a towing vehicle having front wheels, said method comprising:
determining and evaluating at least one dynamic movement input variable;
if a rolling movement of the vehicle combination is detected by means of the evaluation, implementing at least braking interventions for stabilizing the dynamic movement state of the vehicle combination for the towing vehicle; and
producing a yaw moment which counteracts the rolling movement of the vehicle combination, by means of braking interventions which are applied to the front wheels of the towing vehicle; wherein,
braking interventions are implemented at the rear wheels of the towing vehicle; only when a predefined operating state of the vehicle combination is present; and
the braking interventions which are implemented at the rear wheels effect an essentially constant braking at the rear wheels..

31. The method as claimed in claim 30, wherein the predefined operating state of the vehicle combination, in which braking interventions are implemented at the rear wheels, is present if a rolling movement of the vehicle combination is detected at a time when there is no braking by the driver and the vehicle combination is located on an underlying surface with a low coefficient of friction.

32. The method as claimed in claim 30, wherein the predefined operating state of the vehicle combination in which braking interventions are implemented at the rear wheels is present if a rolling movement of the vehicle combination is detected and at a time when there is no braking by the driver and the braking interventions which are applied to the front wheels causes a risk of the front wheels locking.

33. The method as claimed in claim 30, wherein braking interventions are implemented at the rear wheels if a rolling movement of the vehicle combination is detected, there is no braking by the driver, and the vehicle combination is located on an underlying surface with a low coefficient of friction.

34. The method as claimed in claim 30, wherein braking interventions are implemented at the rear wheels if a rolling movement of the vehicle combination is detected, there is no braking by the driver and the braking interventions which are applied to the front wheels lead to a risk of the front wheels locking.

35. The method as claimed in claim 30, wherein the predefined operating state of the vehicle combination in which braking interventions is implemented at the rear wheels is present if a rolling movement is detected during a driver initiated braking process, and vehicle deceleration occurring as a result of the driver initiated braking process fulfills a predefined comparative criterion.

36. The method as claimed in claim 30, wherein braking interventions are implemented at the rear wheels if a rolling movement is detected during a driver initiated braking process, and vehicle deceleration occurring as a result of the driver initiated braking process fulfills a predefined comparative criterion.

37. The method as claimed in claim 36, wherein if the vehicle deceleration which occurs is below a predefined threshold value, a braking effect at the rear wheels as a result of the driver initiated braking process is at least partially reduced by the braking interventions which are brought about for the rear wheels.

38. The method as claimed in claim 37, wherein the braking effect is reduced to such an extent that the value of the vehicle deceleration which has occurred as a result of the driver initiated braking process is at least maintained.

39. The method as claimed in claim 36, wherein if the vehicle deceleration is above a predefined threshold value, the braking effect at the rear wheels as a result of the driver initiated braking process is at least maintained by the braking interventions which are implemented at the rear wheels.

40. The method as claimed in claim 39, wherein if an intervention of an anti-lock brake system is made at or both front wheels, an additional braking effect at the rear wheels is increased by braking interventions which are implemented at the rear wheels.

41. The method as claimed in claim 40, wherein the increase in the additional braking effect at the rear axle is carried out in such a way that the value of the vehicle deceleration which has occurred as a result of the driver initiated braking process which is initiated is maintained.

42. The method as claimed in claim 30, wherein the braking interventions which are applied to the front wheels give rise to braking forces which are composed of a basic force and a dynamic force component.

43. The method as claimed in claim 30, wherein:
at least the towing vehicle is equipped with one of a hydraulic, an electrohydraulic, a pneumatic, and an electropneumatic brake system; and
the braking interventions which are applied to the front wheels are such that a brake pressure which is composed of a basic pressure and dynamic pressure peaks is supplied to wheel brake cylinders assigned to the front wheels.

44. The method as claimed in claim 42, wherein a yaw moment which counteracts a rolling movement of the vehicle combination is produced by the dynamic force component.

45. The method as claimed in claim 42, wherein a value of the basic force or pressure is determined as a function of a deviation in a yaw angle rate, in particular the deviation results from the difference between the actual value for the yaw angle rate which is determined using a yaw angle rate sensor and a setpoint value for the yaw angle rate which is determined using a mathematical model.

46. The method as claimed in claim 42, wherein the value for the dynamic force component is determined as a function of a variable which describes a change over time of a deviation in the yaw angle rate.

47. The method as claimed in claim 43, wherein both the basic pressure and the dynamic pressure peaks decrease as the rolling movement decreases.

48. The method as claimed in claim 30, wherein:
engine interventions are also carried out in addition to braking interventions; and
a moment which is output by the engine is set by means of the engine interventions in such a way that substantially no circumferential forces occur at the driven wheels of the towing vehicle.

49. The method as claimed in claim 30, wherein:
engine interventions are carried out in addition to braking interventions; and
torque which is output by the engine is set by the engine interventions in such a way that friction losses which occur in the drive train are compensated and the driven wheels are given a neutral setting as far as the circumferential force is concerned.

50. The method as claimed in claim 30, wherein:
after stabilizing braking interventions have been initiated, it is checked whether instability of the vehicle combination decreases;
when the vehicle combination has returned to a stable state, no further stabilizing braking interventions are produced; and
at the same time drive torque is set in accordance with a value which is predefined by the driver and which can be derived from the activation of the accelerator pedal.

51. The method as claimed in claim 30, wherein braking interventions are carried out at the front wheels as a function of one of a value of sensed yaw moment which acts in the vehicle and a value of the sensed yaw acceleration.

52. The method as claimed in claim 30, wherein at least a yaw angle rate of the towing vehicle is determined and evaluated as a dynamic movement input variable.

53. The method as claimed in claim 30, wherein vehicle speed, yaw angle rate and steering angle are evaluated to determine whether a rolling movement is occurring.

54. The method as claimed in claim 53, wherein a rolling movement is occurring if the yaw angle rate exhibits an oscillating behavior in an operating state of the vehicle combination in which the vehicle speed is higher than an associated threshold value, even though the driver is not making any steering interventions.

55. The method as claimed in claim 30, wherein the presence of a rolling movement of the vehicle combination is detected as a function of a deviation variable which includes a deviation between actual value of the yaw angle rate and an associated setpoint value.

56. A device for stabilizing a vehicle combination comprising a trailer and a towing vehicle that has front wheels and rear wheels, said device comprising:
means for determining and evaluating at least one dynamic movement input variable;
means for implementing at least braking interventions at the front wheels of the towing vehicle, for stabilizing the dynamic movement state of the vehicle combination if a rolling movement of the vehicle combination is detected by means of the evaluation; wherein,
a yaw moment which counteracts the rolling movement of the vehicle combination is produced by means of the braking interventions at the front wheels of the towing vehicle;
braking interventions for the rear wheels of the towing vehicle are additionally permitted only when a predefined operating state of the vehicle combination is present; and
the braking interventions which are additionally permitted or brought about for the rear wheels effect an essentially constant braking effect at the rear wheels.
